(19) United States
(12) Patent Application Publication
(10) Pub. No.: US 2021/0348597 A1
(43) Pub. Date: Nov. 11, 2021

(54) PILE FOUNDATION AND CONSTRUCTION METHOD OF PILE FOUNDATION

(71) Applicant: TOKYO ELECTRIC POWER SERVICES CO., LTD., Koto-ku, Tokyo (JP)

(72) Inventor: Shigeru Tanabe, Koto-ku, Tokyo (JP)

(73) Assignee: TOKYO ELECTRIC POWER SERVICES CO., LTD., Koto-ku, Tokyo (JP)

(21) Appl. No.: 17/272,877

(22) PCT Filed: Aug. 22, 2019
(86) PCT No.: PCT/JP2019/032855

§ 371 Date: Mar. 2, 2021

(30) Foreign Application Priority Data
Sep. 3, 2018 (JP) 2018-164263

(51) Int. Cl. F03D 13/25; E02D 27/42; E02D 27/52; E02D 27/12

(52) U.S. Cl. CPC F03D 13/25; E02D 27/12; E02D 27/52; E02D 27/42

(57) ABSTRACT

A pile foundation (10) including: a pile (24) that extends in a vertical direction, and whose pile head (24A) protrudes above the ground (26), and that supports a tower-type structure (14), and a floor slab (28) that is installed on the ground (20), and is fixed to the pile head (24A), and that transmits force that is acting on the pile (24) to the ground (20).

### TECHNICAL FIELD

The present disclosure relates to a pile foundation and a method of construction method of pile foundation.

### BACKGROUND ART

Japanese Patent Application Laid-Open (JP-A No. 2006-257749 discloses a foundation pile structure in which a planar pressure bearer is provided on a head portion of a pile (i.e., a pile head) that is embedded in the ground, and a footing that serves as an upper portion structure is disposed above the pressure bearer.

### SUMMARY OF THE INVENTION

### Technical Problem

In a pile foundation that supports a tower type of structure, in order to shorten the construction time, a structure that ensures sufficient resistance to horizontal force without increasing the diameter of pile is required. As described in JP-A No. 2006-257749, a structure in which a pressure bearer is embedded in the ground is one example of such a structure. However, when the pressure bearer is embedded in the ground, it is necessary to firstly excavate the ground which is a large-scale undertaking.

The present disclosure provides a pile foundation and a construction method of pile foundation that may ensure sufficient resistance to horizontal force and that may shorten the construction time.

### Solution to the Problem

A pile foundation according to a first aspect of the present disclosure includes a pile that extends in a vertical direction, that has a pile head protruding above the ground, and that supports a tower-type structure; and a floor slab that is installed on the ground, that is fixed to the pile head, and that transmits force that is acting on the pile to the ground.

In the pile foundation according to the first aspect of the present disclosure, a lower portion of a pile that extends in a vertical direction is embedded in the ground, and a head portion of this pile protrudes above the ground. A tower-type structure is supported by this pile. Further, a floor slab is installed on the ground. This floor slab is fixed to the pile, and is formed so as to enable three that is acting on the pile to he transmitted to the ground. As a result, even if force from the tower-type structure acting in a direction that might cause the pile to topple over is transmitted to the pile, at least a portion of this force can be transmitted from the floor slab to the ground, so that resistance to horizontal force may be secured.

Moreover, the floor slab is fixed to the pile head, which is protruding above the ground, of the pile. As a result, it is not necessary to excavate the ground in advance before laying the floor slab. In other words, the floor slab may be installed in a shorter time compared to a structure in which a supporting plate is embedded in the ground.

In a pile foundation according to a second aspect of the present disclosure, in the first aspect, the pile is disposed coaxially with the tower-type structure.

In the pile foundation according to the second aspect of the present disclosure, by providing the pile on the same axis as the tower-type structure, it is possible to create a monopile foundation that supports the tower-type structure using only a single pile. As a result, it is possible to achieve a reduction in the construction time compared to a structure in which a tower-type structure is supported by plural piles.

In a pile foundation according to a third aspect of the present disclosure, in the first aspect or second aspect, the floor slab is installed under the sea.

In the pile foundation according to the third aspect of the present disclosure, even in a case in which the floor slab is installed under the sea, since it is not necessary to excavate the ground in advance, construction of the pile foundation may be completed without any large-scale equipment being required.

In a pile foundation according to a fourth aspect of the present disclosure, in any one of the first through third aspects, the pile is formed by a steel pipe, and the floor slab is formed from a steel material.

In the pile foundation according to the fourth aspect of the present disclosure, since the pile and the floor slab are formed from the same steel material, in addition to a method in which the floor slab is fixed to the pile head by being mechanically fastened thereto using nuts and bolts and the like, it is also possible to employ a method such as welding or the like.

In a pile foundation according to a fifth aspect of the present disclosure, in any one of the first through third aspects, the floor slab is formed of reinforced concrete as a single integrated body.

In the pile foundation according to the fifth aspect of the present disclosure, it is possible to employ a method in which the pile is firstly driven into the ground, and then concrete is poured to form the floor slab.

In a pile foundation according to a sixth aspect of the present disclosure, in any one of the first through third aspects, the floor slab is structured to include a plurality of reinforced concrete blocks that are joined to the pile head.

In the pile foundation according to the sixth aspect of the present disclosure, by using plural reinforced concrete blocks, it becomes possible to lay a floor slab after the pile has been driven into the ground without concrete having to be poured.

In a pile foundation according to a seventh aspect of the present disclosure, in any one of the first through sixth aspects, the tower-type structure forms a leg portion of a wind power generator.

In the pile foundation according to the seventh aspect of the present disclosure, bending moment generated by a heavy load, such as a wind power generator, does act in a direction that might cause the pile to topple over, however, since bending moment acting in an opposite direction from this bending moment is generated by the floor slab, it is possible to reduce the maximum bending moment that acts on the pile.

A method of constructing a pile foundation according to an eighth aspect of the present disclosure includes driving a pile that supports a tower-type structure into the ground; installing a formwork around a pile head that protrudes above the ground into which the pile has been driven; and placing concrete around the pile head. wherein, when the formwork is being installed, a lower end portion of the formwork is embedded in the ground.

In the method of constructing a pile foundation according to the eighth aspect of the present disclosure, by embedding the lower end portion of the concrete formwork in the ground, this lower end portion of the formwork may he made to function as a wedge, and the floor slab can he inhibited from coming free from the ground.

A method of constructing a pile foundation according to a ninth aspect of the present disclosure includes driving a pile that supports a tower type structure into the ground; and forming an integral floor slab by joining a plurality of blocks to a circumferential surface of a pile head, the pile head protruding above the ground into which the pile has been driven.

In the method of constructing a pile foundation according to the ninth aspect of the present disclosure, by joining separate blocks together so as to form the floor slab, installation of the floor slab may he completed more easily compared to a method in which a floor slab in the form of a single integrated body is joined to a pile head.

### Advantageous Effects of the Invention

As described above, according to the pile foundation and method of constructing a pile foundation of the present disclosure, it is possible to ensure sufficient resistance to horizontal force while enabling the construction time to be shortened.

### BRIEF DESCRIPTION OF THE DRAWINGS

FIG. 1 is a schematic view illustrating an overall view of a wind power generator in which a pile foundation according to a first exemplary embodiment has been applied.

FIG. 2A is an elevational view of the pile foundation according to the first exemplary embodiment.

FIG. 2B is a plan view of the pile foundation according to the first exemplary embodiment.

FIG. 3A is a view illustrating both an devotional view of the pile foundation according to the first exemplary embodiment and directions in which forces are acting.

FIG. 3B is a view illustrating a balance of forces in a structure in which no floor slab is provided.

FIG. 3C is a view illustrating a balance of forces in a structure in which a floor slab is provided,

FIG. 4 is a view illustrating distribution of bending moment which is acting on the pile according to the first exemplary embodiment.

FIG. 5A is an devotional view of a pile foundation according to a second exemplary embodiment.

FIG. 5B is a plan cross-sectional view illustrating a state across a line 5B-5B illustrated in FIG. 5A.

FIG. 6A is an elevational view of a pile foundation according to a first modified example of the second exemplary embodiment.

FIG. 6B is a plan cross-sectional view illustrating a state across a line 6B-6B illustrated in FIG. 6A.

FIG. 7A is an elevational view of a pile foundation according to a second modified example of the second exemplary embodiment.

FIG. 7B is a plan cross-sectional view illustrating a state across a line 7B-7B illustrated in FIG. 7A.

FIG. 8A is an elevational view of a pile foundation according to a third modified example of the second exemplary embodiment.

FIG. 8B is a plan view of the pile foundation according to the third modified example of the second exemplary embodiment.

FIG. 9A is an enlarged view illustrating principal portions of a pile head according to the third modified example of the second exemplary embodiment.

FIG. 9B is a perspective view illustrating blocks forming a floor slab according to the third modified example of the second exemplary embodiment.

FIG. 10A is an elevational view of a pile foundation according to a third exemplary embodiment.

FIG. 10B is a plan cross-sectional view illustrating a state across a line 10B-10B illustrated in FIG. 10A.

### DESCRIPTION OF THE EMBODIMENTS

### First Exemplary Embodiment

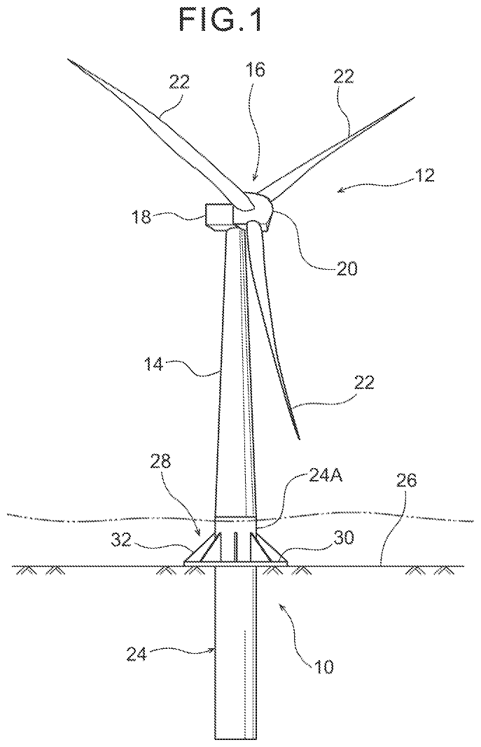

A pile foundation 10 according to a first exemplary embodiment will now be described with reference to the drawings. As illustrated in FIG. 1, the pile foundation 10 of the present exemplary embodiment serves as a foundation to support a wind power generator 12.

The wind power generator 12 is structured to include a leg portion (i.e., a tower) 14 serving as a tower-type structure that extends in a vertical direction from the pile foundation 10, and a wind turbine portion 16 that is provided on an upper end portion of the leg portion 14. The wind turbine portion 16 is structured to include a nacelle 18, a hub 20, and blades 22.

The leg portion 14 is formed so as to become progressively smaller in diameter approaching the upper portion thereof, and a lower end of this leg portion 14 is connected to the pile foundation 10. The nacelle 18 that structures part of the wind turbine 16 is mounted on the upper end portion of the leg portion 14 so as to he able to rotate freely around this upper end portion, and an electricity generator and an amplifier and the like, not illustrated in the drawings, are housed within this nacelle 18.

The nacelle 18 is connected to the hub 20 via a rotor shaft, not illustrated in the drawings. The plural rotating blades 22 are attached to the hub 20 and, in the present exemplary embodiment, as an example, three blades 22 are attached to a circumferential surface of the hub 20.

The leg portion 14 of the wind power generator 12 that is structured in the above-described manner is supported on the pile foundation 10. Here, the pile foundation 10 of the present exemplary embodiment is structured to include a pile 24 and a floor slab 28.

The pile 24 is formed by a steel pipe whose axial direction extends in a vertical direction, and is disposed on substantially the same axis as the leg portion 14 of the wind power generator 12. Portions of the pile 24 other than a pile head 24A, that is provided in an upper portion thereof, are driven into the ground 26 using a pile-driving construction method. Here, in the present exemplary embodiment, since the pile 24 is used in the pile foundation 10 of an offshore wind power generator 12, the pile 24 is driven into the ocean bed, and is driven to a depth of approximately 4 to 6 times the pile diameter of the pile 24 from the ground surface of the ground 26. In the present exemplary embodiment, as an example, a pile 24 having a pile diameter of 8 meters is used, so that the pile 24 is driven to a depth of approximately 40 meters from the surface of the ground 26.

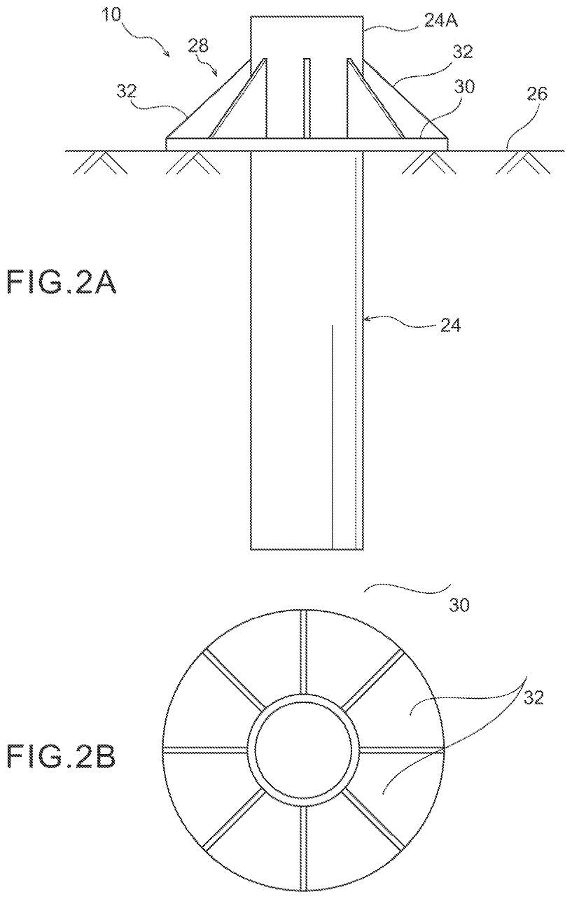

The pile bead 24A protrudes above the ground 26, and the floor slab 28 is provided on this pile head 24A. Due thereto, the floor slab 28 is located under the sea. As illustrated in FIG. 2A, the floor slab 28 is structured to include a base 30 and triangular plates 32.

The base 30 is formed such that a thickness direction thereof extends in the axial direction of the pile 24 (i.e., in the vertical direction), and the base 30 is installed on the ground 26. As illustrated in FIG. 2B, the base 30 is formed in a substantially circular shape so as to be concentric with the pile 24 when looked at in plan view. Further, in the present exemplary embodiment, as an example, the base 30 is formed from a steel material, and is fixed to a circumferential surface of the pile head 24A. As the method to fix the base 30 to the pile head 24A, other than welding, a method employing mechanical fastening using nuts and bolts or the like, may be employed.

Plural triangular plates 32 are provided on art tipper surface side of the base 30. Eight of the triangular plates 32 are provided at equidistant intervals from each other in a circumferential direction of the pile 24, and each of the triangular plates 32 is formed substantially in a triangular shape such that one rectilinear portion thereof extends in a direction along the pile 24, and another rectilinear portion thereof extends in a direction along the base 30.

A lower end surface of each triangular plate 32 extends in a radial direction of the pile 24 along the base 30, and is fixed to the upper surface of the base 30. Further, a side surface of each triangular plate 32 that is positioned closest to the center of the pile 24 extends in the vertical direction along the pile head 24A, and is fixed to the pile head 24A. As the method used to fix the triangular plates 32 to the base 30 and the pile head 24A, other than welding, a method employing mechanical fastening using nuts and bolts or the like, may be employed, in the same way as for the base 30.

As described above, the floor slab 28 is installed on top of the ground 26, and is fixed to the pile head 24A. Due to this, a structure is created m which external force acting on the pile 24 is transmitted. to the ground 26 via the floor slab 28.

(Method of Constructing a Pile Foundation)

Next, an example of a method of constructing the pile foundation 10 of the present exemplary embodiment will be described. Firstly, in a state in which the pile 24 and the floor slab 28 are mutually separated from each other, the pile 24 is driven to a predetermined depth into the ground 26 using a pile-driving construction method. When pile-driving construction method is employed, not only a case in which the ground 26 is a sandy ground or comparatively soft gravel ground, the pile 24 can even be constructed in (i.e., pile-driven into) soft rock.

Next, the floor slab 28 is fixed to the driven pile 24. Here, in the present exemplary embodiment, since this operation involves fixing the floor slab 28 to the pile head 24A under the sea, a method may be employed in which the floor slab 28 is formed with the triangular plates 32 attached in advance to the base 30, and in this state, the floor slab 28 is fitted over the pile bead 24A from the upper side of the pile 24, and is then installed on the ground 26.

Alter the floor slab 28 has been installed on the ground 26, the base 30 and the triangular plates 32 are fixed to the pile head 24A using a predetermined method. In this manner, the pile foundation 10 is constructed.

(Actions)

Next, actions of the present exemplary embodiment will he described.

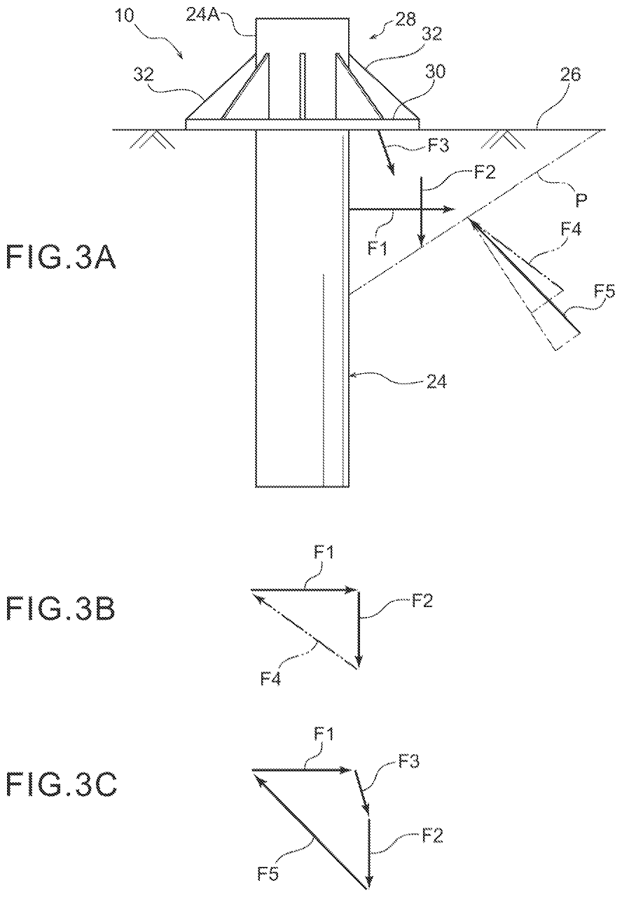

In the pile foundation 10 of the present exemplary embodiment, the floor slab 28 is installed on the ground 26, and this floor slab 28 is fixed to the pile 24 and is structured to transmit any force acting on the pile 24 to the ground 26. As a result, even in a case in which external three acting in a direction that might cause the pile 24 to topple over is input from the leg portion 14 of the wind power generator 12, which is a tower-type structure, to the pile 24, at least a portion of this external force can be transmitted to the ground 26 via the floor slab 28, so that the ability of the pile 24 to withstand horizontal force may be secured. This action will now be described in detail with reference to FIG. 3.

As illustrated in FIG. 3A, horizontal force F1 acts in a horizontal direction on the pile 24 of the pile foundation 10. This horizontal three F1 is an external force that is input into the pile 24 as a result of wind blowing onto the wind power generator 12 (see FIG. 1).

In contrast, a three F2 acting downwardly in the vertical direction is input into a slip plane P in the ground. 26. This force F2 is a force that is generated by the weight of the ground 26.

Here, a case in which a pile foundation with no floor slab 28 provided, will be considered. In a pile foundation of this type, as illustrated by the double-dot chain line in FIG. 3B, a combined force F4 formed by the horizontal force F1 and the force F2 generated by the weight of the ground 26 acts as a counterforce on the slip plane P in the ground 26. The resistance of the pile is determined by the slippage of the soil mass at the upper portion of the pile 24.

In contrast to this, in the pile foundation 10 in which the floor slab 28 is provided, as the case in the present exemplary embodiment, as illustrated in FIG. 3A, as a result of external force acting in a direction that might cause the pile 24 to topple over (i.e., in the direction of the horizontal force H1, a force F3 acts in a diagonally downward direction on the ground 26 from the base 30 of the floor slab 28.

Due to the above, in the pile foundation 10 in which the floor slab 28 is provided, as illustrated by FIG. 3C, in addition to the horizontal force F1 which is acting on the pile 24 and the force F2 generated by the weight of the ground 26, a combined force F5 formed by these and. by the force F3 acting in a diagonally downward direction on the ground 26 from the floor slab 28 acts as a counterforce on the slip plane P in the ground 26.

Here, the combined force F5 is greater than the combined force F4 in the structure in which the floor slab 28 is not provided. Further, since the force in the vertical direction is greater in the combined force F5 than in the combined force F4, the slip resistance three of the lumps of earth can also be increased. in this way, the amount of displacement in a horizontal direction of the pile 24 may be reduced.

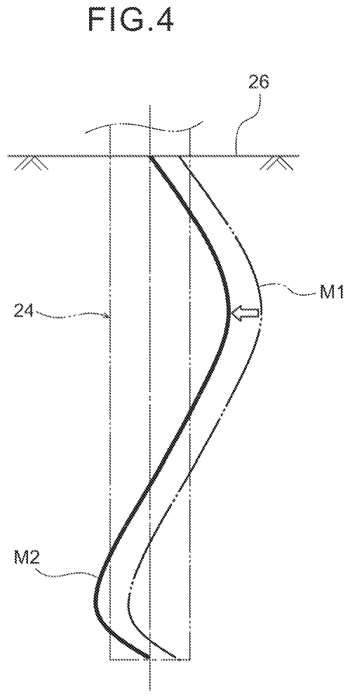

Moreover, as illustrated in FIG. 4, by providing the floor slab 28 on the pile head 24A, it is possible to cause the entire moment distribution to slide, and to thereby reduce the maximum bending moment. Note that in FIG. 4, in order to facilitate the description, the pile 24 is illustrated using virtual lines (i.e., double-dot chain lines), and the floor slab 28 has been omitted from the drawing.

A bending moment M1 illustrated using a virtual line in FIG. 4 illustrates a distribution of bending moment in a pile foundation in a case in which the floor slab 28 is not provided, while a bending moment M2 illustrated using a solid line in FIG. 4 illustrates a distribution of bending moment in a structure in a case in which the floor slab 28 is provided.

The bending moment M1 and the bending moment M2 are generated in cases in which a horizontal force is acting on the pile 24 in a direction towards the right side as seen in the drawing, however, in the bending moment M2, the maximum betiding moment that is generated in the pile 24 is reduced as a result of bending moment from the floor slab 28 (see FIG. 3) acting thereon in the opposite direction from the horizontal force. As a result, the cross-sectional yield strength that is required in the pile 24 can be designed to be smaller. In other words, even in a case in which the diameter of the pile 24 is reduced, or a case in which the thickness of the steel pipe used to form the pile 24 is reduced, it may still secure sufficient resistance to horizontal force.

Moreover, in the present exemplary embodiment, the floor slab 28 is fixed to the pile head 24A that protrudes above the ground 26. and this floor slab 28 is installed on top of the ground 26. As a result, it is not necessary to excavate the ground 26 beforehand when installing the floor slab 28. In other words, compared with a structure in. which supporting plates or the like are embedded in the ground 26, the floor slab 28 may be installed in a shorter time, and the time required to construct the pile foundation 10 may be shortened.

Furthermore, in the present exemplary embodiment, as illustrated in FIG. 1, by providing the pile 24 such that the pile 24 is coaxial with the leg portion 14 of the wind power generator 12, it is possible to create a monopile foundation in which the leg portion 14 is supported by a single pile 24. As a result, compared with a structure in which a tower-type structure such as the wind power generator 12 or the like is supported by constructing plural piles 24, a reduction in the construction time may he achieved.

Furthermore, even when the structure is one in which the floor slab 28 is installed offshore, a.s in the present exemplary embodiment, if a monopile foundation constructed using a pile-driving construction method is used, then, this eliminates the need to excavate the ground 26 beforehand, and construction of the pile foundation 10 may be completed without any large-scale equipment 1being required.

Moreover, in the present exemplary embodiment, the pile 24 and the floor slab 28 are formed from the same steel material. Due thereto, in addition to a method in which the floor slab 28 is fixed to the pile head 24A by being mechanically fastened thereto using nuts and bolts and the like, it is also possible to fix the floor slab 28 to the pile head 24A using a method such as welding or the like.

### Second Exemplary Embodiment

Next, a pile foundation 40 according to a second exemplary embodiment will be described with reference to the drawings. Note that component elements that are similar to those of the first exemplary embodiment are given the same descriptive symbols and any description thereof is omitted when this is appropriate.

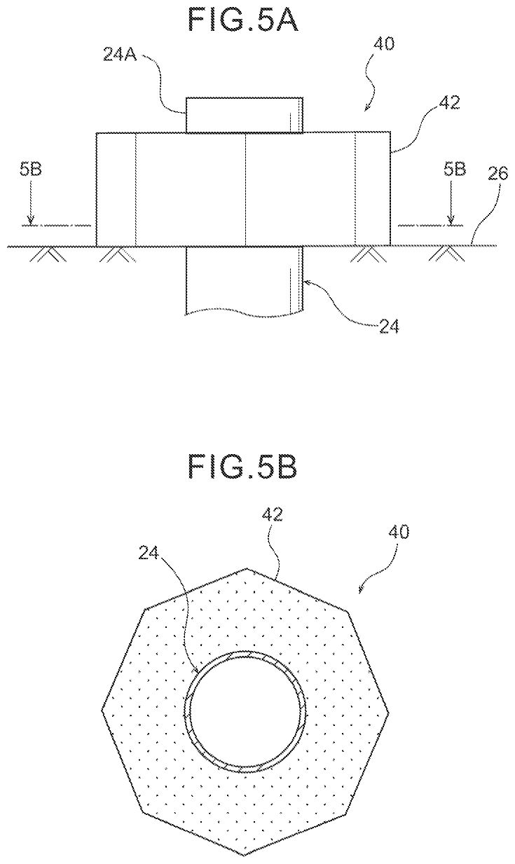

As illustrated in FIG. 5A, the pile foundation 40 of the present exemplary embodiment is structured to include the pile 24 and a floor slab 42, and the floor slab 42 is provided on the pile head 24A on the upper portion of the pile 24. Note that, in FIG. 5A, only the pile foundation 40 is illustrated, however, in the same way as in the first exemplary embodiment, a wind power generator is provided on the upper side of this pile foundation 40 (see FIG. 1). The same applies in the second exemplary embodiment and third exemplary embodiment that are described below.

As illustrated in FIG. 5B, the floor slab 42 is structured by reinforced concrete in a substantially regular octagonal shape when looked at in plan view. The floor slab 42 is installed on the ground 26 by placing concrete around the pile head 24A. Note that steel rods (not illustrated in the drawings) are used as reinforcement inside the floor slab 42. As has been stated above, the floor slab 42 is formed as a single integrated body from reinforced concrete.

(Actions)

Next, actions of the present exemplary embodiment will be described.

In the pile foundation 40 of the present exemplary embodiment, the floor slab 42 can be formed by placing concrete after the pile 24 has been pile-driven into the ground 26. In particular, in the case of a structure in which the floor slab 42 is provided on land instead of offshore, forming the floor slab 42 using reinforced concrete may enable a large-size floor slab to be formed easily. The remaining actions are similar to those of the first exemplary embodiment.

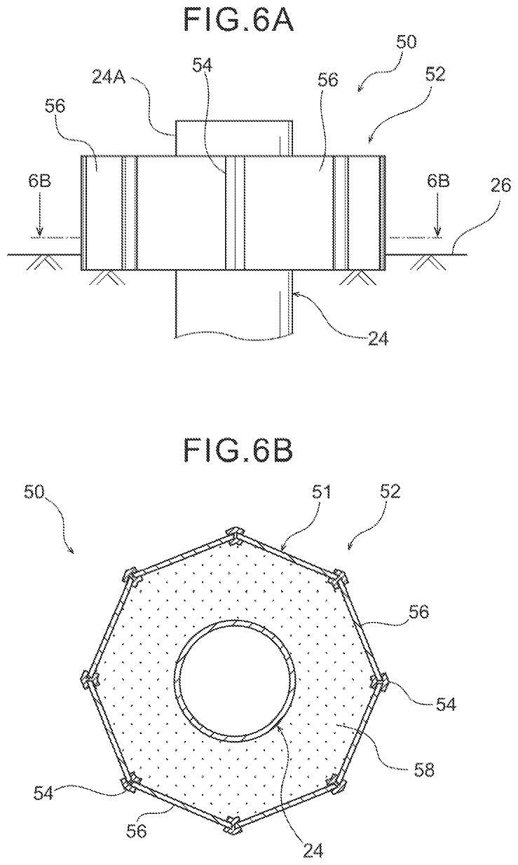

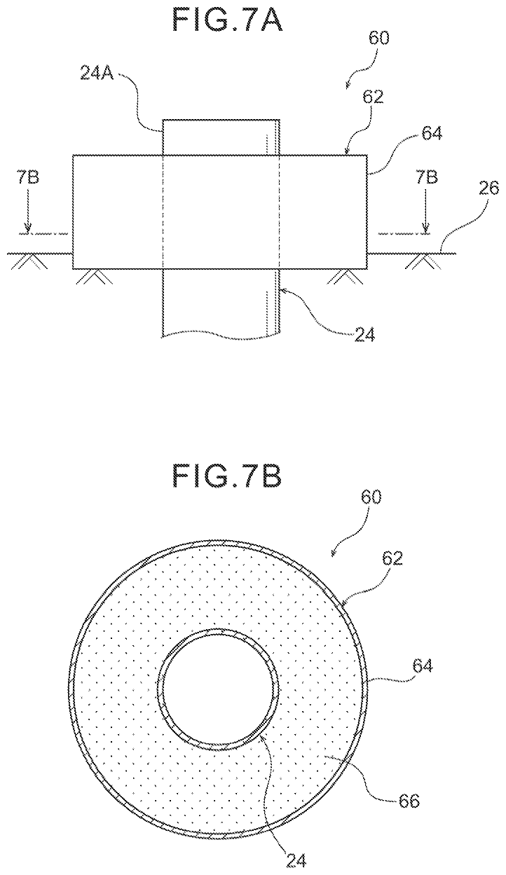

Note that, in the present exemplary embodiment the floor slab 42 is formed as a single integrated body from reinforced concrete, however, the present disclosure is not limited to this and it is also possible to employ the structures of the modified examples illustrated in FIG. 6 and FIG. 7.

### FIRST MODIFIED EXAMPLE

As illustrated in FIG. 6A, a floor slab 52 structuring a pile foundation 50 of a first modified example is formed in a substantially regular octagonal shape when looked at in plan view, and is structured to include a formwork 51, which is structured to include lengths of H-steel 54 and steel plates 56, and concrete 58. The floor slab 52 of the present modified example is what is known as a steel-concrete composite floor slab that is formed by integrating the steel formwork 51 and the concrete 58 into a single body.

The lengths of H-steel 54 forming part of the formwork 51 are steel components that have a substantially H-shaped cross-section and extend in a vertical direction, and a lower end portion of each length of H-steel 54 is embedded in the ground 26. Moreover, as illustrated in FIG. 6B, eight lengths of H-steel 54 are provided at equidistant intervals from each other in the circumferential direction of the pile 24, and these lengths of H-steel 54 form part of an apex portion of the substantially regular octagonal-shaped floor slab 52. Moreover, orientations of the respective lengths of H-steel 54 are all aligned such that the web portions thereof are positioned on straight lines that pass through a central axis of the pile 24.

The steel plates 56 are provided between mutually adjacent lengths of H-steel 54. Because of this, eight steel plates 56 are provided. Both end portions of the respective steel plates 56 are inserted between flanges of the lengths of H-steel 54. Moreover, as illustrated in FIG. 6A, a lower end portion of each steel plate 56 is embedded in the ground 26.

As illustrated in FIG. 6B, the concrete 58 is poured around the pile 24. This concrete 58 fills the space between the formwork 51 and the pile 24.

An example of a method of constructing the pile foundation 50 will now be described. Firstly, the pile 24 is driven to a predetermined depth into the ground 26 using a pile-driving construction method. Next, the formwork 51 is installed around the periphery of the pile head 24A. In this step of installing the formwork 51, the lengths of H-steel 54 are pile-driven into the ground 16 around the periphery of the pile head 24A, and the steel plates 56 are then pile-driven into position between the previously pile-driven lengths of H-steel 54. As a result, the lower end portion of each length of H-steel 54 and the lower end portion of each steel plate 56 are embedded. in the ground 26.

After the lengths of H-steel 54 and the steel plates 56 have been installed, concrete is poured between the lengths of H-steel 54 and steel plates 56 and the pile head 24A. Due thereto, the pile foundation 50 is constructed by integrating the concrete 58 and the lengths of H-steel 54 and steel plates 56 into a single body.

As described above, in the present modified example, by embedding the lower end portion of the formwork 51 of the concrete 58 into the ground 26, the lower end portion of the formwork 51 can be made to function as a wedge. As a result, it is possible to inhibit the floor slab 52 that is installed on top of the ground 26 from coming free (i.e., from being lifted up) from the ground 26.

### SECOND MODIFIED EXAMPLE

As illustrated in FIG. 7A and FIG. 7B, a floor slab 62 forming part of a pile foundation 60 of the second modified example is structured to include a formwork 64 and concrete 66.

The formwork 64 is formed in a substantially circular cylinder shape from a steel material, and a lower end portion of this formwork 64 is embedded in the ground 26. The concrete 66 is poured into the space between the formwork 64 and the pile head 24A.

The method used to construct the pile foundation 60 is similar to that used in the first modified example. In other words, after the pile 24 has been driven to a predetermined depth into the ground 26 using a pile-driving construction method, the formwork 64 is installed around the periphery of the pile head 24A. At this time, a lower portion of the formwork 64 is embedded into the ground 26. By placing the concrete 66 after the formwork 64 has been installed, the pile foundation 60 is constructed.

### THIRD MODIFIED EXAMPLE

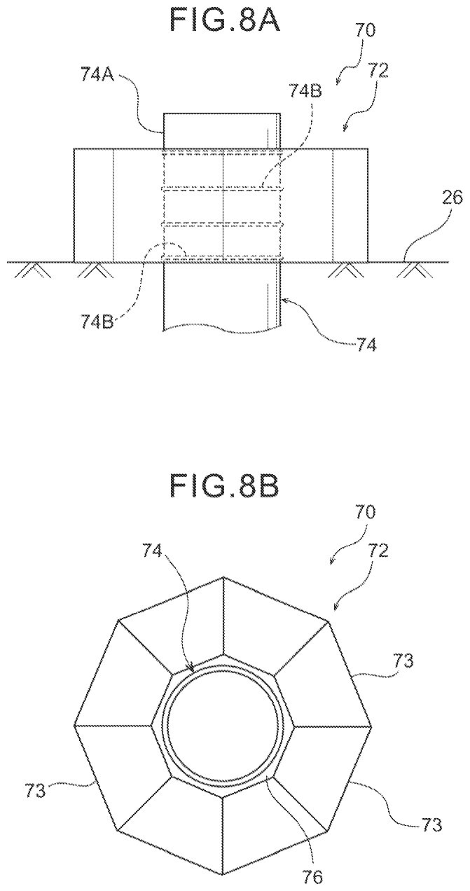

As illustrated in FIG. 8A, a pile foundation 70 of the third modified example is structured to include a pile 74 and a floor slab 72. The pile 74 is formed by a steel pipe whose axial direction extends in the vertical direction. Portions thereof other than a pile head 74A that is provided in an upper portion thereof are driven into the ground 26 using a pile-driving construction method.

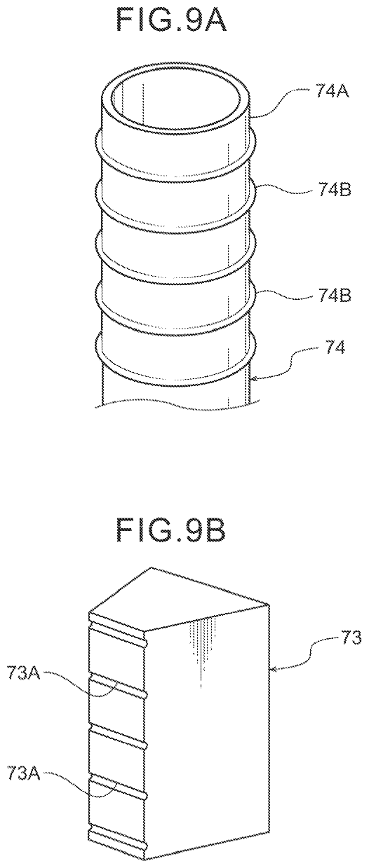

As illustrated in FIG. 9A, plural toroidal projections 74B are formed on the pile head 74A of the pile 74. Here, as an example, five toroidal projections 74B are formed at equidistant intervals from each other in an axial direction.

As illustrated in FIG. 8A, the floor slab 72 is provided on the pile head 74A. Further, as illustrated in FIG. 8B, the floor slab 72 is structured to include plural reinforced concrete blocks 73. As an example, the floor slab 72 may be structured to include eight blocks 73.

As illustrated in FIG. 9B, the blocks 73 are formed having a substantially trapezoidal shape when seen in plan view, and. extends in the vertical direction. Further, plural recessed portions 73A are formed in a side surface of the blocks 73 that faces towards the pile 74. Five of the recessed portions 73A are formed substantially at equidistant intervals from each other in the vertical direction, and the positions where these five recessed portions 73A are formed correspond respectively to the toroidal protections 74B that are formed on the pile head 74A. Further, the shape of the respective recessed portions 73A is formed so as to correspond to the shape of the toroidal projections 74B.

As illustrated in FIG. 8BB, eight blocks 73 are disposed around the periphery of the pile head 74A, and the pile head 74A and the blocks 73 are formed into a single integrated body using grout 76. Mutually adjacent blocks 73 are also bonded together using either the grout 76 or another type of bonding component.

Here, an example of a method of constructing the pile foundation 70 will be described. Firstly; the pile 74 is driven to a predetermined depth into the ground 26 using a pile-driving construction method (see FIG. 9A). Next, the blocks 73 are disposed around the periphery of the pile head 74A. Next, the grout 76 is poured between the respective blocks 76 and the pile head 74A, so as to bond the blocks 73 and the pile head 74A together.

Note that mutually adjacent blocks 73 may be bonded together in advance, or alternatively, mutually adjacent blocks 73 may be bonded together at the same time as the pile head 74A and the blocks 73 are bonded together. By bonding the plural blocks 73 in this way, the integrated floor slab 72 is formed.

In the pile foundation 70 of the present modified example, by using the plural reinforced concrete blocks 73, it is possible to install the floor slab 72 after pile-driving the pile 74 into the ground without having to pour concrete.

Moreover, by bonding together separate blocks 73 in order to form the floor slab 72, installation of the floor slab can be completed more easily compared to a. method in which the single-body floor slab 72 is joined to the pile head 74A. For example, in a case in which the present disclosure is applied to the pile foundation of an offshore wind power generator, the floor slab 72 may be separated into individual blocks and transported to the construction site.

### THIRD EXEMPLARY EMBODIMENT

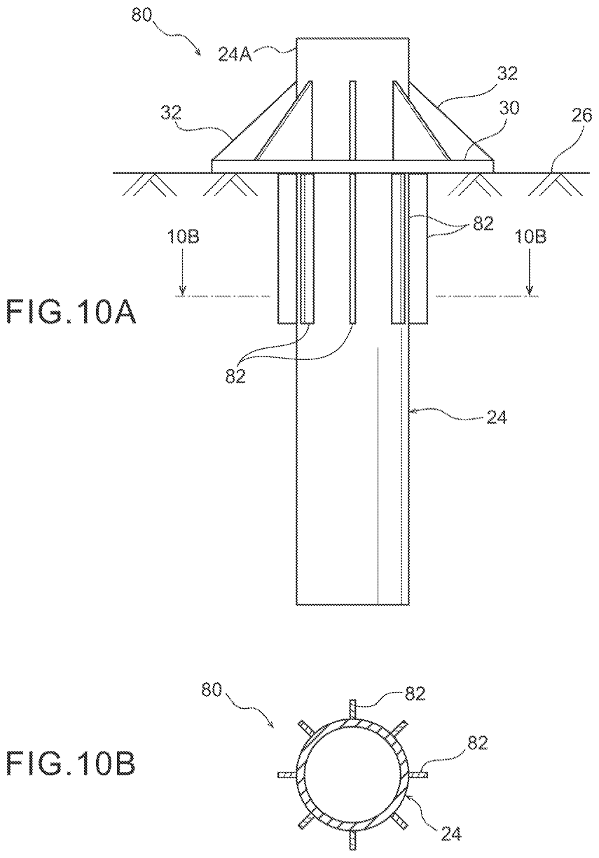

Next, a pile foundation 80 according to a third exemplary embodiment will be described with reference to FIG. 10. Note that component elements that are similar to those of the first exemplary embodiment are given the same descriptive symbols and any description thereof is omitted when this is appropriate. The present exemplary embodiment differs from the first exemplary embodiment in that ribs 82 are provided.

As illustrated in FIG. 10A, the pile foundation 80 of the present exemplary embodiment is structured to include the pile 24 and the floor slab 28. Additionally, plural ribs 82 are formed on the pile 24.

The ribs 82 extend in the vertical direction, and are formed on a portion of the pile 24 that is embedded into the ground 26. Moreover, as illustrated in FIG. 10B, the ribs 82 protrude in a radial direction from the circumferential surface of the pile 24, and eight ribs 82 are formed at equidistant intervals from each other in the circumferential direction of the pile 24.

The eight ribs 82 are each formed having substantially the same thickness and substantially the same length in the vertical direction. Further, the ribs 82 are each formed in a substantially rectangular plate shape whose longitudinal direction extends in the vertical direction.

(Actions)

Next, actions of the present exemplary embodiment will be described.

In the pile foundation 80 of the present exemplary embodiment, in addition to the actions provided by the pile foundation 10 of the first exemplary embodiment, the eight ribs 82 that are embedded in the ground 26 enable the resistance to horizontal force acting on the pile 24 to be increased. In other words, by forming the ribs 82, the slip plane in the ground 26 is changed to the distal end portion of the ribs 82 instead of being in the vicinity of the circumferential surface of the pile 24. Due thereto, compared to a structure in which there are no ribs 82, it is possible to increase the resistance acting on the pile 24 from the ground

First through third exemplary embodiments of the present disclosure as well as modified examples thereof have been described above, however, it should be understood that various modifications and the like may be made thereto insofar as they do not depart from the spirit or scope of the present disclosure. For example, in the above-described exemplary embodiments, a description is given of a pile foundation that supports a wind power generator that is serving as a tower-type structure. However, the present disclosure is not limited to this. In other words, the present disclosure may instead be applied to a pile foundation that supports another tower-type structure, or to a pile foundation that supports a tower-type structure such as a steel tower. In this case, by pile-driving plural piles into the ground, it is possible to support a tower-type structure such as a steel tower.

Moreover, in the above-described exemplary embodiments, a monopile foundation that supports a wind power generator by a single pile has been described. However, the present disclosure is not limned to this, and may be applied to other types of foundations. For example, the present disclosure may also be applied to a tripod type of foundation in which three piles are pile-driven into the ground, and these three piles are linked together so as to support a wind power generator. In this case, by providing independent floor slabs respectively for each of the piles, the same type of actions as those demonstrated in the above-described exemplary embodiments may be obtained.

Furthermore, in the above-described exemplary embodiments, the piles are formed by steel pipes, however, the material used to form the piles is not limited to this, and the piles may instead be formed from another type of material. For example, wooden piles made from wood and concrete piles made from concrete may also be used. It is also possible to use a combination of these materials. Moreover, in a case in which piles formed by steel pipes are used, in order to increase the strength and rigidity of the piles, it is also possible to pour concrete into the interior of the steel pipes. For example, if a large bending moment is acting on the upper portion of a pile, then by placing concrete into the interior of the upper portion of this pile, the strength and rigidity of the upper portion of the pile may be increased.

Priority is claimed on Japanese Patent Application No. 2018-164263, filed Sep. 3, 2018, the disclosure of which is incorporated herein by reference.

All references, patent applications and technical specifications cited in the present specification are incorporated by reference into the present specification to the same extent as if the individual references, patent applications and technical specifications were specifically and individually recited as being incorporated by reference.

1. A pile foundation comprising:
a pile that extends in a vertical direction, that has a pile head protruding above the ground, and that supports a tower-type structure; and
a floor slab that is laid on the ground, that is fixed to the pile head, and that transmits force that is acting on the pile to the ground.

2. The pile foundation according to claim 1, wherein the pile is disposed so as to be coaxial with the tower-type structure.

3. The pile foundation according to claim 1, wherein the floor slab is laid in the ocean.

4. The pile foundation according to claim 1, wherein the pile is formed by a steel pipe, and the floor slab is formed from a steel material.

5. The pile foundation according to claim 1, wherein the floor slab is formed as a single integrated body from reinforced concrete.

6. The pile foundation according to claim 1, wherein the floor slab is formed so as to include a plurality of reinforced concrete blocks that are joined to the pile head.

7. The pile foundation according to claim 1, wherein the tower-type structure forms a leg portion of a wind power generator.

8. A method of constructing a pile foundation, comprising:
driving a pile that supports a tower-type structure into the ground;
installing a formwork around a pile head, which is protruding above the ground, of the driven pile; and
pouring concrete around the pile head,
wherein, when the formwork is being installed, a lower end portion of the formwork is embedded in the ground.

9. A method of constructing a pile foundation, comprising:
driving a pile that supports a tower-type structure into the ground; and
forming an integral floor slab by joining a plurality of blocks to a circumferential surface of a pile head, which is protruding above the ground, of the driven pile.
